(19) United States
(12) Patent Application Publication
(10) Pub. No.: US 2015/0085071 A1
(43) Pub. Date: Mar. 26, 2015

(54) SYSTEM FOR GENERATING AND RECEIVING A STEREOSCOPIC 2D-BACKWARD-COMPATIBLE VIDEO STREAM, AND METHOD THEREOF

(71) Applicant: Ruiz Rodriquez Ezequiel, Panama (PA)

(72) Inventor: Ruiz Rodriquez Ezequiel, Panama (PA)

(21) Appl. No.: 14/390,489

(22) PCT Filed: Apr. 4, 2012
(86) PCT No.: PCT/EP2012/056117

§ 371 Date: Oct. 30, 2014

(51) Int. Cl. H04N 13/00; H04N 21/482; H04N 21/643; H04N 21/43; H04N 21/81

(52) U.S. Cl. CPC H04N 13/0051; H04N 13/0059; H04N 13/0066; H04N 21/4307; H04N 21/816; H04N 21/64322; H04N 21/482
USPC 348/43

(57) ABSTRACT

A system includes: first receiving means for receiving a first sequence of images; first storing means for storing the first sequence of images; second receiving means for receiving a data signal including information transformable in a second sequences of images; second storing means for storing the data signal related to the second sequence. The first sequence and the data signal each includes data packets. Each data packet includes a header, and a payload having audio/video data. The header of each data packet includes a first data field having first information identifying the service of the content, and a second data field having second information identifying a program start time and/or a program title. The system includes synchronizing means for combining each first-sequence data packet with each data-signal data packet, in order to generate a compound sequence representing a 3D image.

The present application claims priority from PCT Patent Application No. PCT/EP2012/056117 filed on Apr. 4, 2012, the disclosure of which is incorporated herein by reference in its entirety.

### 1. FIELD OF THE INVENTION

It is noted that citation or identification of any document in this application is not an admission that such document is available as prior art to the present invention.

The present invention relates to a system for generating and receiving a stereoscopic 2D-backward-compatible video stream according to the preamble of claim 1.

The present invention also relates to a method for generating and receiving a stereoscopic 2D-backward-compatible video stream.

In the present description, “stereoscopic 2D-backward-compatible video stream” substantially means a video stream which, when appropriately processed in a 3D receiving and visualisation device, produces sequences of images which are perceived by a viewer as being three-dimensional, while when is processed in a conventional 2D receiving device (MPEG 2 or MPEG 4) allows the viewer to watch a full 2D image all over the screen associated to said receiving device.

Therefore the system and the method according to the present invention allow a user having a conventional and non-stereoscopic decoder or television set or visualisation device to display images in 2D even if transmitted in 3D format, while allowing the user to see 3D content in the case he/she has a stereoscopic displaying apparatus.

In recent years, the cinematographic production world has paid much attention and has devoted huge resources to the production of stereoscopic 3D contents, in particular under the stimulus of new production tools made available by the new digital technologies.

The interest in 3D is now extending to domestic use, i.e. for displaying images on a television set, lap-top or a similar visualisation device. For example, some pay-TV operators started already to broadcast 3D programs.

The most common approach to presenting stereoscopic video contents involves displaying two independent video streams intended for the right eye and for the left eye, respectively, which are then reassembled by the human brain into three-dimensional objects.

In this frame, a number of measures must be taken during the production process in order to reduce the hit-rate required for content transfer and fruition.

The stereoscopic video stream consisting of composite frames is then compressed in order to reduce its transport bit-rate before distributing it on a broadcasting network, an IP network or a mass memory medium.

The compression technique mostly used at present for distributing video contents are the ones defined by the MPEG2 standard and by the MPEG4 standard (or H.264/AVC standard); in particular, high-definition television sets currently available on the market are equipped with H.264/AVC decoders supporting format decoding up to the 1080p format.

One of the most important requirements on which the attention of the various service providers (especially public service broadcasters) is focused, is the backward compatibility of the stereoscopic signals.

In fact, it is desirable that a 3D content can be displayed by both 2D and 3D television sets and monitors, and this result can be achieved by simultaneously broadcasting both the 2D and 3D versions of one program; of course, this option, called simulcast, involves wasting bandwidth, which is one thing that service providers would rather avoid.

At the state of the art, several techniques are known for generating backward-compatible stereoscopic streams.

One of these technique relates to the application of so-called “depth maps”, as described, for example, in US patent applications no. US 2002/0048395 and no. US 2004/0101043.

Another backward-compatible stereoscopic stream coding technique is, for example, the one referred to as “multiview”.

A common character of these two techniques is the fact that the stereoscopic video stream is compressed into a base layer (the 2D base stream) plus an enhancement layer, which transports the second view.

The syntax of the coded stream ensures that the 2D video can also be decoded by old-generation decoders, so long as they comply with the MPEG2 or H.264/AVC standards, in this way creating the backward compatibility. Unfortunately the bandwidth needed for the enhancement layer is similar to the bandwidth needed for the 2D base stream, presenting almost the same drawbacks of the simulcast transmissions.

Therefore, the techniques known at the state of the art do not allow, in an efficient way, a user having a conventional (complying with MPEG2 or MPEG4 standard) and non-stereoscopic decoder or television set or visualisation device to display images in 2D even if transmitted in 3D format, while allowing the user to see 3D content in the case he/she has a stereoscopic displaying apparatus.

Moreover, it has been suggested in the state of the art a system comprising:
first receiving means, in particular comprising a non-stereoscopic decoder, for receiving a first sequence of images apt to be displayed on a visualization device;
second receiving means for receiving a data signal comprising information which can be transformed in a second sequences of images that together with said first sequence of images, allows to reconstruct a stereoscopic video stream.

A drawback of said known system is constituted by the fact that it does not comprise means apt to synchronize said first and second sequence of images for properly reconstructing a stereoscopic video stream.

In fact, said first and second sequence of images must be correctly synchronized in order to properly display a stereoscopic video stream, i.e. each image of the first sequence of images must be correctly synchronized and coupled with the corresponding image of the second sequence of images; if this does not happen, it is sufficient a little difference (just one frame being shifted) in the combination of the images coming from said first and second sequence of images that the human eyes perceive the resulting image as being of bad quality and do not perceive the resulting image as being stereoscopic.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention, does not intend to encompass within the scope of the invention any previously disclosed product, process of making the product or method of using the product, which meets the written description and enablement requirements of the USPTO (35 U.S.C. 112, first paragraph), such that applicant(s) reserve the right to disclaim, and hereby disclose a disclaimer of, any previously described product, method of making the product, or process of using the product.

### SUMMARY OF THE INVENTION

In this frame, it is the main object of the present invention to overcome the above-mentioned drawbacks and to provide a system and a method for generating and receiving a stereoscopic 2D-backward-compatible video stream.

In particular, it is an object of the present invention to indicate an efficient system and a method for allowing a user having a conventional and non-stereoscopic visualisation device (i.e. a decoder and TV set only equipped with MPEG2 or MPEG4 standard) to display images in 2D even if transmitted in 3D format, while allowing the user to see 3D content in the case he/she has a stereoscopic displaying apparatus.

Another object of the present invention is to indicate a system and a method for generating and receiving a stereoscopic-2D backward-compatible video stream comprising means apt to correctly synchronize a first and a second sequence of images for properly reconstructing a stereoscopic video stream, in the case of 3D transmission.

It is a further object of the present invention to provide a system and a method apt to rebuild at the receiving side a 3D video stream which can be distributed by a broadcaster in a conventional manner for the 2D view, without using additional bandwidth for the second stereoscopic view, while the second view is supplied through an additional channel of transmission, different from the first one.

These objects are achieved by the present invention through a system and a method for generating and receiving a stereoscopic-2D backward-compatible video stream, incorporating the features set out in the appended claims, which are intended as an integral part of the present description.

### BRIEF DESCRIPTION OF THE DRAWINGS

FIG. 1 represents a block diagram of a first embodiment of a system for generating and receiving a stereoscopic and 2D backward-compatible video stream according to the present invention;

FIG. 2 represents a data packet according to the system and method of the present invention;

FIG. 3 represents a block diagram of a second embodiment of a system for generating and receiving a stereoscopic and 2D backward-compatible video stream according to the present invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

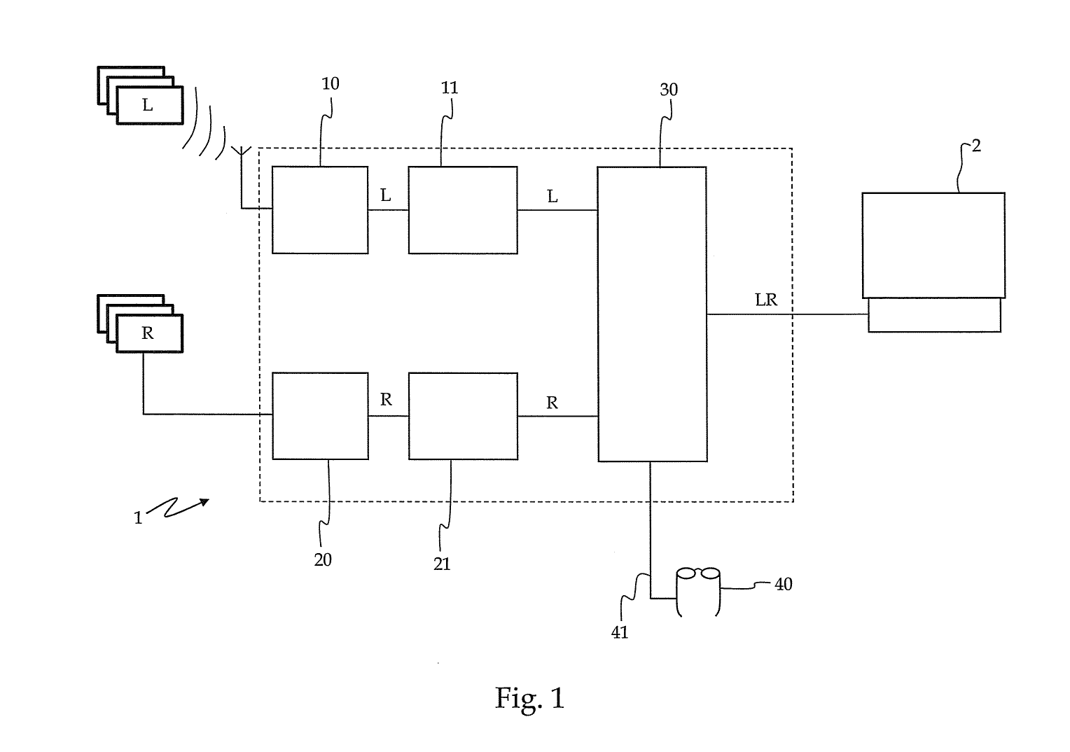

In FIG. 1, reference number 1 indicates a first embodiment of a system for generating and receiving a stereoscopic 2D-backward-compatible video stream according to the present invention.

Said system 1 comprises first receiving means 10, in particular comprising a non-stereoscopic decoder, for receiving a first sequence L of images apt to be displayed on a 3D visualization device 2.

In particular, said non-stereoscopic decoder complies with the MPEG2 (or even MPEG4) standard and said first sequence L of images may comprise a 2D video stream or a 2D content of a stereoscopic video stream.

Moreover, said system 1 comprises:
first storing means 11 associated to said first receiving means 10 for storing, in particular frame by frame, said first sequence L of images;
second receiving means 20 for receiving a data signal R comprising information which can be transformed in a second sequences of images that together with said first sequence L of images, allows to reconstruct a stereoscopic video stream; said second receiving means 20 therefore reconstructs the second video stream related to the sequence R of images;
second storing means 21 associated to said second receiving means 20 for storing, in particular frame by frame, said data signal related to said second sequence R.

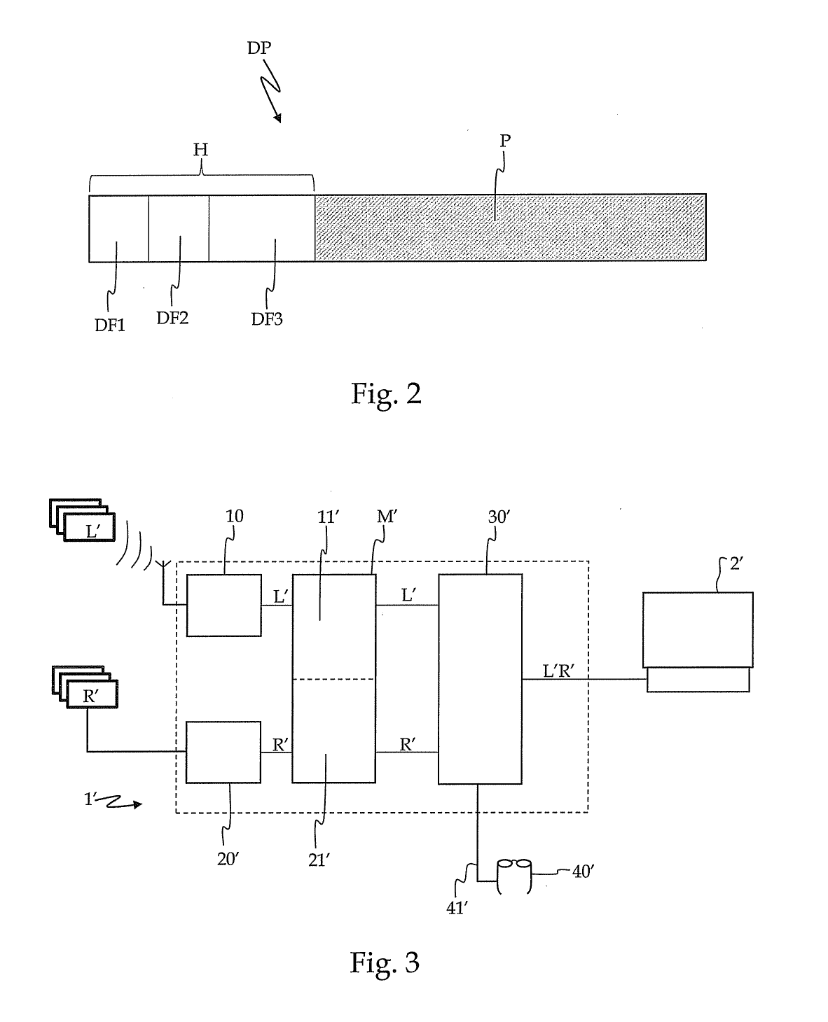

Said first sequence L and said data signal R include a plurality of data packets DP, each data packet DP being related to a video frame and comprising at least a header H and a payload P including audio/video data; in this respect, it must be noted that FIG. 2 relates to an exemplary embodiment of a data packet DP according to the present invention.

In accordance with the present invention, said header H of each data packet DP comprises a first data field DF1 comprising a first information identifying the service (e.g. Das Erste, ZDF, RTL, and so on) of the content and at least a second data field DF2 comprising a second information identifying a program start date and time and/or a program tide and a clock. The clock data are made counting, since the beginning of the program, the fraction of seconds (for instance 25 or 50 frame per second), the seconds, minutes and hours since the relevant program started. In this way every frame of the stereoscopic images is perfectly identified.

An example on how the data fields DF1 and DF2 can be arranged in a precise moment for the relevant frame is the following:
DF1: Das Erste;
DF2: starting time: 07:03:2012-20:15-20 (frame) 45 (sec.) 10 (min.) 1 (h) or “Die Nonne und der Kommissar—Verflucht” 20 (frame) 45 (sec.) 10 (min.) 1 (h).

Further, in accordance with the present invention said system 1 comprises synchronizing means 30 for combining, on the basis of said first data field DF1 and said at least a second data field DF2, each data packet DP of said first sequence L of images stored by said first storing means 11 with each data packet DP of said data signal R stored by said second storing means 21, in order to generate a compound sequence LR representative of a 3D image apt to be displayed on said 3D visualization device 2.

It must be pointed out that, according to the present invention, said second data field DF2 needs not to be a clock with a perfectly exact day dining, since said information relating to a program start time (as also said information relating to the service of the content) needs only to contain the data or information for allowing the synchronizing means 30 to univocally identify the frames of a same video stream coming from said first sequence L and from said data signal R, in order to correctly generate a compound sequence LR of images representative of a 3D image.

In a preferred embodiment, said header H of each data packet DP further comprises a third data field DF3 comprising a third information, identifying the data packet number, i.e. every frame. So, starting since the beginning of a certain video program every field is numbered starting from 0 up to the last frame number of said video program.

It is clear that said third data field DF3 facilitates the work of said synchronizing means 30 in combining each data packet DP of said first sequence L of images stored by said first storing means 11 with each data packet DP of said data signal R stored by said second storing means 21, in order to generate a compound sequence LR of images representative of a 3D image apt to be displayed on said visualization device 2.

Preferably, said first sequence L of images comprises a video stream intended for the left eye; moreover, said data signal R may comprise a video stream intended for the right eye.

Therefore, it is clear that the system 1 according to the present invention allows to correctly synchronize said first sequence L of images and said second sequence R obtained from data signal R in order to properly provide and display a stereoscopic video stream.

In fact, each data packet DP of the first sequence L of images is correctly identified and synchronized and coupled with the corresponding data packet DP of the data signal R; therefore, thanks to the peculiar provisions of the present invention, the user cannot perceive any difference of the images coming from said two different sources, and he/she can correctly perceive a resulting image as being stereoscopic and having good quality.

Moreover, the system 1 according to the present invention allows a user having a conventional and non-stereoscopic decoder (i.e. a decoder complying with MPEG2 or MPEG4 standard), but having a 3D display set to display on a visualisation device not only images in 2D, but also images in 3D or stereoscopic, obtained from the two streams of L and R images.

In fact, said first receiving means 10 receive a first sequence L of images, for example intended for a left eye, and said second receiving means 20 receive a data signal R, for example a second sequence of images intended for a right eye. Then, said first storing means 11 store said first sequence L of images and said second storing means 21 store said data signal R related to said second sequence R; thereafter, said synchronizing means 30 mix the first sequence L of images and said second sequence R in order to generate a compound sequence LR of images representative of a 3D image to be displayed on said visualization device 2.

However, it is clear that the system 1 according to the present invention can also be used for displaying images in 2D, since said synchronizing means 30 may send to said visualization device 2 only the first sequence L of images or images resulting from the data signal R.

It therefore appears that the system 1 according to the present invention is versatile, since it allows a plurality of different utilizations of the visualization device 2, especially when the user has available only a conventional 2D receiving device (MPEG 2 or MPEG 4) it allows the viewer to watch a full 2D image all over the screen associated to said receiving device.

It is clear that with the method and system according to the present invention, the part that is broadcasted with the MPEG 2 or MPEG 4 format is receivable and viewable with a simple MPEG TV receiver, also without making use of the system 1.

Moreover, it must be noted that the system 1 according to the present invention may be a set-top-box separate from the visualization device 2 (e.g. television set) or it may be built in the visualization device 2 itself.

In a preferred embodiment, said second receiving means 20 comprise means able to receive an Internet signal, for example coming from a router, a Wi-Fi access point, and so on.

Moreover, said first storing means 11 comprise a first buffer memory 12 (not shown in the FIG. 1) and said second storing means 21 comprise a second buffer memory 22 (not shown in the FIG. 1) for storing said first sequence L of images and said data signal R respectively.

Said system 1 may further comprise extracting means 40 for properly visualize the 3D image displayed on said visualization device 2.

In particular, said extracting means 40 may comprise specialized eyewear comprising synchronized LCD shutter, polarizers, colour filters, or similar means apt to selectively block said first sequence L of images or said second sequence R of the compound sequence LR; this provision allows to properly visualize the 3D image displayed on said visualization device 2.

Therefore, said extracting means 40 are preferably associated with the synchronizing means 30 in order to synchronize the shutter speed of the extracting means 40 with the mixing speed imparted from said synchronizing means 30.

In particular, said extracting means 40 are associated with the synchronizing means 30 through a control line 41.

Moreover, the system 1 according to the present invention may comprise an Electronic Program Guide (also known at the state of the art as “EPG”) allowing to select a content comprising audio/video data to be downloaded as a first sequence L of images and as data signal related to said second sequence R in order to automatically start the download of said content, in particular by means of a key (e.g. by pressing a key of a remote control and/or by activating a key of said EPG).

In this case, said EPG of the system 1 may advantageously comprise a feature apt to provide the time necessary for completing the download. It is clear that with the provision, for instance, of an EPG programming tool the downloading can start hours or days before the actual beginning of the 3D program, so that when the first sequence L is broadcasted, the receiver has already downloaded (totally or partially, depending on the speed of the Internet connection) the other sequence R and the 3D reproduction is working perfectly.

FIG. 3 represents a block diagram of a second embodiment of a method and a system for generating and receiving a stereoscopic-compatible video stream according to the present invention.

In the embodiment shown in FIG. 3, the same reference numbers of FIG. 1 have been utilized, with the addition of an apostrophe (').

The system 1′ shown in FIG. 3 comprises:
first receiving means 10′, in particular comprising a non-stereoscopic decoder, for receiving a first sequence L′ of images apt to be displayed on a visualization device 2′.
first storing means 11′ associated to said first receiving means 10′ for storing said first sequence L′ of images;
second receiving means 20′ for receiving a data signal related to said second sequence R′ comprising information which, together with said first sequence L′ of images, allows to reconstruct a stereoscopic video stream;
second storing means 21′ associated to said second receiving means 20′ for storing said data signal related to said second sequence R′;
synchronizing means 30′ for combining, on the basis of said first data field DF1 and said at least a second data field DF2, and/or DF3, each data packet DP of said first sequence L′ of images stored by said first recording means 12′ with each data packet DP of said data signal related to said second sequence R′ stored by said second recording means 22′, in order to generate a compound sequence L′R′ of images representative of a 3D image apt to be displayed on said visualization device 2′.

In the embodiment shown in FIG. 3, said first storing means comprise at least a first portion 12′ of a solid state memory M′, said first portion 12′ being apt to store said first sequence L′ of images; moreover, said second storing means comprise at least a second portion 22′ of said solid state memory M′, said second portion 22′ being apt to store said data signal relating to said second sequence R′.

It is clear that said first 12′ and second portion 22′ may also be constituted by two separated solid state memories M′ (not shown in the attached figures).

The provision of the solid state memory M′ is particularly useful in the case said second receiving means 20′ comprise means able to receive an Internet signal; in fact, in this case there may be a problem of receiving, with a sufficiently fast bit rate, the signal relating to said data signal R′. The size especially of said second portion 22′ of the memory can be of some dozen of gigabytes for storing a complete entertainment show of a couple of hours. With a hard disk of 256 gigabytes it is therefore possible to store tens of events.

In particular it has to be highlighted that, also in the embodiment shown in FIG. 3, in order to properly display on said visualization device 2′ a 3D image, it is necessary to appropriately synchronize said first sequence L′ of images and said second sequence R′ like described for the embodiment shown in FIG. 1. In fact, an erroneous synchronization of the two signals (even if said erroneous synchronization relates to a single frame) jeopardizes and prejudices the efficiency of the resulting 3D images.

Therefore, according to the present invention, said first sequence L′ of images and said data signal related to said second sequence R′ are respectively stored on said at least first 12′ and second portion 22′ of a solid state memory M′ for a determined period of time, that substantially depends on the Internet hit rate.

In fact, if the Internet hit rate is sufficiently high, said period of time may be of few seconds or minutes. On the contrary, if the Internet bit rate is low; said period of time may have the duration of some minutes or a duration corresponding to the entire download of the data signal R, R′.

Therefore, thanks to the provision of a solid state memory M′, the synchronizing means 30′ have enough time to receive the downloaded said data signal R′ and to appropriately synchronize said first sequence L′ of images and said second sequence R′ as previously described with reference to the embodiment of FIG. 1.

According to the present invention, the method for generating and receiving a stereoscopic-compatible video stream comprises the steps of:
a) receiving a first sequence L, L′ of images apt to be displayed on a visualization device 2, 2′ by means of first receiving means 10, 10′, in particular comprising a non-stereoscopic decoder;
b) storing said first sequence L, L′ of images in first storing means 11, 11′ associated to said first receiving means 10, 10′;
c) receiving a data signal R, R′ by means of second receiving means 20, 20′, said data signal R, R′ comprising information which can be transformed in a second sequences or images R, R that together with said first sequence L, L′ of images, allows to reconstruct a stereoscopic video stream;
d) storing said data signal related to said second sequence R, R′ in second storing means 21, 21′ associated to said second receiving means 20, 20′,
said first sequence L; L′ and said data signal related to said second sequence R; R′ including a plurality of data packets DP, each data packet DP comprising at least a header H and a payload P including audio/video data.

According to the present invention, said method further comprises the step e) of combining said first sequence L, L′ and said data signal related to said second sequence R, R′ by means of synchronizing means 30, 30′ apt to generate a compound sequence LR, L′R′ representative of a 3D image apt to be displayed on said visualizadon device 2, 2′, said combining step e) being performed on the basis of a first data field DF1 of said header H of each data packet DP, said first data field DF1 comprising a first information identifying the service (e.g. RAI1, RAI2, LA7, and so on of the content, and at least a second data field DF2 of said header H of each data packet DP, said second data field DF2 comprising a second information identifying a program start time and/or a program title. In a preferred embodiment, said step e) can also be performed, in particular, on the basis of a third data field DF3 of said header H of each data packet DP, said third data field DF3 comprising a third information identifying the data packet number.

Moreover, according to the method of the present invention:
said step c) of receiving a data signal R; R′ can be performed by means of an Internet signal receiving means;
said step b) can be performed by a first buffer memory 12 apt to store said first sequence L of images or by at least a first portion 12′ of a solid state memory M′ apt to store said first sequence L′ of images;
said step d) can be performed by a second buffer memory 22 apt to store said data signal related to said second sequence R or by at least a second portion 22′ of said solid state memory M′, said second portion 22′ being apt to store said data signal R′.

The method according to the present invention may further comprise a step f) of visualizing the 3D image displayed on said visualization device 2, 2′ by means of extracting means 40, 40′, in particular said visualizing step f) being performed through the association of said extracting means 40, 40′ with said synchronizing means 30, 30′ in order to synchronize the shutter speed of the extracting means 40, 40′ with the mixing speed imparted from said synchronizing means 30; 30′.

Moreover, the method according to the present invention may comprise a step g) of selecting from an Electronic Program Guide (“EPG”) a content comprising audio/video data to be received as a first sequence L, L′ of images and as data signal related to said second sequence R, R′ to be downloaded through Internet, in order to automatically start the download of said content, related to said second sequence R,R′, in particular by means of a key (e.g. by pressing a key of a remote control and/or by activating a key of said EPG).

Advantageously, said step g) can be performed in such a way to provide the time necessary for completing the download by the system 1, 1′.

The advantages offered by a system and a method for generating a stereoscopic-compatible video stream according to the present invention are apparent from the above description.

In particular, a first advantage consist in the fact that the system 1, 1′ according to the present invention allows to correctly synchronize said first sequence L, L′ of images and said related to said second sequence R, R′ in order to properly display a stereoscopic video stream, since each data packet DP of the first sequence L, L′ of images is correctly synchronized and coupled with the corresponding data packet DP of the data signal R, R′.

Therefore, thanks to the peculiar provisions of the present invention, the user cannot perceive any difference of the images coming from said two different sources, and he can perceive a resulting compound image as being stereoscopic and having good quality.

Moreover, the system 1, 1′ allows a user having a conventional and non-stereoscopic receiver (i.e. a decoder complying with MPEG2 or MPEG 4 standard) to allow the viewer to watch a full 2D image all over the screen associated to said receiving device even if transmitted in 3D format, while allowing the user to see 3D content in the case he/she has a stereoscopic displaying apparatus.

A further advantage of the system and of the method according to the present invention consists in the fact that it allows to rebuild a video stream which can be distributed by a broadcaster without wasting bandwidth, in particular using substantially the same bandwidth required for a 2D stream. In fact, thanks to the system and method according to the present invention, the broadcaster is in the position of separately broadcasting a first video stream intended for a left eye and a second video stream intended for a right eye, and this option allows to avoid wasting bandwidth.

A further advantage of the system and a method according to the present invention consists in the fact that the system 1, 1′ is versatile, since it allows a plurality of different utilizations of the visualization device 2, 2′. In fact, the system 1, 1′ according to the present invention can also be used for displaying images in 2D, since said synchronizing means 30, 30′ may send to said visualization device 2, 2′ only the first sequence L, L′ of images or the images resulting from the data signal R, R′.

Therefore, the system and the method according to the present invention allow to display both a 2D image, both a 3D image of good quality.

The system and method described herein by way of example may be subject to many possible variations without departing from the novelty spirit of the inventive idea; it is also clear that in the practical implementation of the invention the illustrated details may have different devices or be replaced with other technically equivalent elements, as well as providing different sequences of steps.

It can therefore be easily understood that the present invention is not limited to the above-described system and method, but may be subject to many modifications, improvements or replacements of equivalent parts and elements without departing from the inventive idea, as clearly specified in the following claims.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A system for generating and receiving a stereoscopic 2D-backward-compatible video stream, the system comprising:
a first receiving means for receiving a first sequence of images configured to be displayed on a visualization device;
a first storing means associated with said first receiving means for storing said first sequence of images;
a second receiving means for receiving a data signal comprising information which corresponds to a second sequences of images, an which can be combined with said first sequence of images to reconstruct a stereoscopic video stream;
a second storing means associated with said second receiving means for storing said data signal related to said second sequence;
wherein said first sequence and said data signal each includes a plurality of data packets, each data packet comprising at least a header, and a payload including audio/video data;
wherein said header of each data packet comprises:
a first data field comprising a first information identifying a service of the content; and
a second data field comprising a second information identifying program start time and/or a program title; and
wherein said system further comprises:
a synchronizing means for combining, on the basis of said first data field and said second data field, each data packet of said first sequence of images with each data packet of said data signal related to said second sequence in order to generate a compound sequence representative of a 3D image configured to be displayed on said visualization device.

2. The system according to claim 1;
wherein said header of each data packet further comprises:
a third data field comprising a third information identifying the data packet number.

3. The system according to claim 1;
wherein said second receiving means comprises a means for receiving an Internet signal.

4. The system according to claim 1;
wherein said first storing means comprises a first buffer memory for storing said first sequence of images; and
wherein said second storing means comprises a second buffer memory for storing said data signal related to said second sequence.

5. The system according to claim 1;
wherein said first storing means comprises a first portion of a solid state memory, said first portion being configured to store said first sequence of images upon receipt of the first sequence by the first receiving means.

6. The system according to claim 5;
wherein said second storing means comprises a second portion of said solid state memory, said second portion being configured to store said data signal related to said second sequence of images upon receipt of the data signal by the second receiving means.

7. The system according to claim 1, further comprising:
an extracting means for properly visualizing the 3D image displayed on said visualization device.

8. The system according to claim 1, further comprising:
an Electronic Program Guide configured to select a content, comprising at least one audio/video data selected from the group consisting of the first sequence of images and the data signal related to said second sequence, in order to automatically start a download of said content from the Internet.

9. The system according to claim 8;
wherein said Electronic Program Guide comprises a feature configured to provide time necessary for completing the download of the content from the Internet.

10. A method for generating and receiving a stereoscopic 2D-backward-compatible video stream, said method comprising the steps of:
(a) receiving a first sequence of images configured to be displayed on a visualization device by means of a first receiving means;
(b) storing said first sequence of images in a first storing means associated with said first receiving means;
(c) receiving a data signal by means of a second receiving means, said data signal comprising information which corresponds to a second sequence of images, and which can be combined with said first sequence of images to reconstruct a stereoscopic video stream;
(d) storing said data signal related to said second sequence in a second storing means associated with said second receiving means;
wherein said first sequence and said data signal each include a plurality of data packets, each data packet comprising at least a header, and a payload including audio/video data;
wherein said header of each data packet comprises:
a first data field comprising a first information identifying service of the content; and
a second data field comprising a second information identifying a program start time and/or a program title; and
wherein said method further comprises the step of:
(e) combining said first sequence of images and said data signal related to said second sequence by means of a synchronizing means to generate a compound sequence representative of a 3D image configured to be displayed on said visualization device;
wherein said combining step (e) is performed on the basis of the first data field and the second data field.

11. The method according to claim 10;
wherein said header of each data packet further comprises:
a third data field comprising a third information identifying the data packet number; and
wherein said step (e) is further performed on the basis of the third data field.

12. The method according to claim 10;
wherein said step (c) is performed by means of an Internet signal receiving means.

13. The method according to claim 10;
wherein said step (b) further comprises:
storing said first sequence of images in a first buffer memory of the first storage means.

14. The method according to claim 10;
wherein said step (d) further comprises:
storing said data signal in a second buffer memory of the second storage means.

15. The method according to claim 10, further comprising the step of:
(f) visualizing the 3D image displayed on said visualization device by means of an extracting means.

16. The method according to claim 10, further comprising the step of:
(g) selecting, from an Electronic Program Guide, a content, comprising at a one audio/video data selected from the group consisting of the first sequence of images and the data signal related to said second sequence, in order to automatically start a download of said content from the Internet.

17. The method according to claim 16;
wherein said step (g) further comprises providing time necessary for completing the download of the content from the Internet.

18. The system according to claim 1;
wherein the first receiving means comprises a non-stereoscopic decoder.

19. The system according to claim 7;
wherein the extracting means is associated with the synchronizing means in order to synchronize a shutter speed of the extracting means with a mixing speed imparted from said synchronizing means.

20. The method according to claim 10;
wherein the first receiving means comprises a non-stereoscopic decoder.

21. The method according to claim 10;
wherein said first storing means comprises a first portion of a solid state memory; and
wherein said step (b) further comprises:
storing said first sequence of images in the first portion of the solid state memory.

22. The method according to claim 21;
wherein said second storing means comprises a second portion of said solid state memory; and
wherein said step (d) further comprises:
storing said data signal in the second portion of said solid state memory.

23. The method according to claim 15;
wherein said step (f) is performed through the association of said extracting means with said synchronizing means in order to synchronize a shutter speed of the extracting means with time mixing speed imparted from said synchronizing means.
